(19) United States
(12) Patent Application Publication
(10) Pub. No.: US 2022/0166797 A1
(43) Pub. Date: May 26, 2022

(54) ELECTRONIC DEVICE AND METHOD FOR CONTROLLING THEREOF

(71) Applicant: Samsung Electronics Co., Ltd., Suwon-si (KR)

(72) Inventors: Dongryeol SHIM, Suwon-si (KR); Junyoung PARK, Suwon-si (KR)

(21) Appl. No.: 17/531,166

(22) Filed: Nov. 19, 2021

Related U.S. Application Data
(63) Continuation of application No. PCT/KR2021/012062, filed on Sep. 6, 2021.

(30) Foreign Application Priority Data
Nov. 20, 2020 (KR) 10-2020-0156229
Feb. 3, 2021 (KR) 10-2021-0015636

(51) Int. Cl. H04L 29/06; G06F 16/23; H04L 9/32; H04L 29/12

(52) U.S. Cl. CPC H04L 63/166; G06F 16/2365; H04L 61/2007; H04L 61/256; H04L 9/3263

(57) ABSTRACT

An electronic device and a method thereof are provided. The electronic device includes a memory, and a processor configured to, based on a first signal requesting generation of a first container being input to a container management module, identify whether the first container is able to communicate using transport layer security (TLS) based on information included in the first signal through a security module, based on the identification that the first container is unable to communicate using the TLS, obtain first certificate data for communicating using the TLS based on the information included in the first signal through a certificate data management module, generate a first proxy container that is able to communicate using the TLS based on the first certificate data through the container management module, and control so that a signal inputted to access the first container is input to the first container via the first proxy container.

### CROSS-REFERENCE TO RELATED APPLICATION(S)

This application is a continuation application, claiming priority under § 365(c), of an International Application No. PCT/KR2021/012062, filed on Sep. 6, 2021, which is based on and claims the benefit of a Korean patent application number 10-2020-0156229, filed on Nov. 20, 2020, in the Korean Intellectual Property Office, and of a Korean patent application number 10-2021-0015636, filed on Feb. 3, 2021, in the Korean Intellectual Property Office, the disclosure of each of which is incorporated by reference herein in its entirety.

### BACKGROUND

### 1. Field

The disclosure relates to an electronic device and a method for controlling thereof. More particularly, the disclosure relates to an electronic device which reinforces security of communication performed between a container and an external device and a method for controlling thereof.

### 2. Description of Related Art

Along with development of communication technologies, reinforcement of security of communication is becoming important issue. Accordingly, various communication encryption methods for reinforcing communication security are currently being developed. Particularly, in the communication using Internet protocol, a Layer 4 (Transport Layer) Security (or TLS) protocol based on a public key certificate for ensuring security of packet is widely used. In a case of using the TLS protocol, sniffing that may occur during a process of transmitting and receiving the packet between different users may be prevented.

With respect to the technology of the related art, in order to apply the TLS to an application, it is necessary to implement a TLS logic directly on the application or directly distribute a reverse proxy or a sidecar proxy having a TLS termination function. Thus, it is necessary to apply the TLS to the application by directly issuing and managing the public key certificate, which may cause inconvenience. In addition, the communication security is deteriorated due to generation of a security hole, if a developer does not apply the TLS to the application.

The above information is presented as background information only to assist with an understanding of the disclosure. No determination has been made, and no assertion is made, as to whether any of the above might be applicable as prior art with regard to the disclosure.

### SUMMARY

Aspects of the disclosure are to address at least the above-mentioned problems and/or disadvantages and to provide at least the advantages described below. Accordingly, an aspect of the disclosure is to provide an electronic device which automatically applies TLS to a container when generating the container and a method for controlling thereof.

Additional aspects will be set forth in part in the description which follows and, in part, will be apparent from the description, or may be learned by practice of the presented embodiments.

In accordance with an aspect of the disclosure, an electronic device is provided. The electronic device includes a memory, and a processor configured to, based on a first signal requesting generation of a first container being input to a container management module, identify whether the first container is able to communicate using TLS based on information included in the first signal through a security module, based on the identification that the first container is unable to communicate using the TLS, obtain first certificate data for communicating using the TLS based on the information included in the first signal through a certificate data management module, generate a first proxy container that is able to communicate using the TLS based on the first certificate data through the container management module, and control so that a signal inputted to access the first container is input to the first container via the first proxy container.

In accordance with another aspect of the disclosure, a method for controlling an electronic device is provided. The method includes based on a first signal requesting generation of a first container being input to a container management module, identifying whether the first container is able to communicate using TLS based on information included in the first signal through a security module, based on the identification that the first container is unable to communicate using the TLS, obtaining first certificate data for communicating using the TLS based on the information included in the first signal through a certificate data management module, generating a first proxy container that is able to communicate using the TLS based on the first certificate data through the container management module, and performing control so that a signal inputted to access the first container is input to the first container via the first proxy container.

As described above, according to the various aspects of the disclosure, the electronic device may enhance user's convenience by automatically applying the TLS to each container and reduce security hole which may occur when the TLS is not applied.

Other aspects, advantages, and salient features of the disclosure will become apparent to those skilled in the art from the following detailed description, which, taken in conjunction with the annexed drawings, discloses various embodiments of the disclosure.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 is a block diagram schematically illustrating a configuration of an electronic device according to an embodiment of the disclosure;

FIG. 2 is a diagram illustrating operations of various modules of the electronic device according to an embodiment of the disclosure;

FIG. 3 is a flowchart illustrating a method for controlling the electronic device according to an embodiment of the disclosure;

FIG. 4 is a flowchart illustrating a process in which the electronic device identifies whether a first container is able to perform communication by using TLS according to an embodiment of the disclosure;

FIG. 5 is a flowchart illustrating a process in which the electronic device obtains certificate data according to an embodiment of the disclosure;

FIG. 6 is a flowchart illustrating a process in which the electronic device performs communication with an external device according to an embodiment of the disclosure; and

FIG. 7 is a block diagram specifically illustrating the configuration of the electronic device according to an embodiment of the disclosure.

Throughout the drawings, it should be noted that like reference numbers are used to depict the same or similar elements, features, and structures.

### DETAILED DESCRIPTION

The following description with reference to the accompanying drawings is provided to assist in a comprehensive understanding of various embodiments of the disclosure as defined by the claims and their equivalents. It includes various specific details to assist in that understanding, but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions may be omitted for clarity and conciseness.

The terms and words used in the following description and claims are not limited to the bibliographical meanings, but are merely used by the inventor to enable a clear and consistent understanding of the disclosure. Accordingly, it should be apparent to those skilled in the art that the following description of various embodiments of the disclosure is provided for illustration purposes only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

The disclosure relates to an electronic device which identifies whether a TLS function is autonomously applied to a container when the container is generated, generates a proxy container capable of performing the TLS function based on the identified result to perform an operation of forcing the container to perform the TLS function, and a method for controlling thereof.

Hereinafter, the disclosure will be described in detail with reference to the drawings.

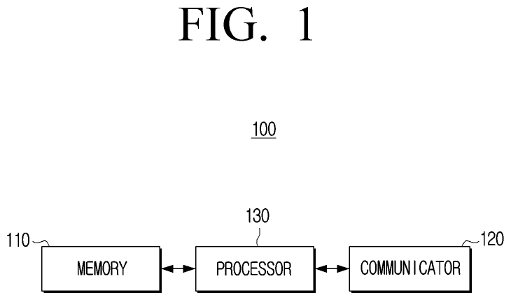

FIG. 1 is a block diagram schematically illustrating a configuration of an electronic device according to an embodiment of the disclosure.

Referring to FIG. 1, the electronic device 100 may include a memory 110, a communicator 120, and a processor 130. However, the configuration illustrated in FIG. 1 is a diagram for implementing embodiments of the disclosure, and the electronic device 100 may further include appropriate hardware and software configurations apparent to those skilled in the art.

The memory 110 may store instructions or data related to at least another constituent element of the electronic device 100. The memory 110 may be accessed by the processor 130 and reading, recording, editing, deleting, or updating of the data by the processor 130 may be executed. The memory 110 may store programs, data, and the like for configuring various screens to be displayed in a display area of a display.

The term memory as used in the disclosure may include the memory 110, a ROM (not illustrated) and a RAM (not illustrated) in the processor 130, or a memory card (not illustrated) (e.g., micro SD card or memory stick) mounted on the electronic device 100. The memory 110 may include a non-volatile memory capable of holding stored information, even if the power supply is interrupted, and a volatile memory that needs continuous power supply to hold the stored information.

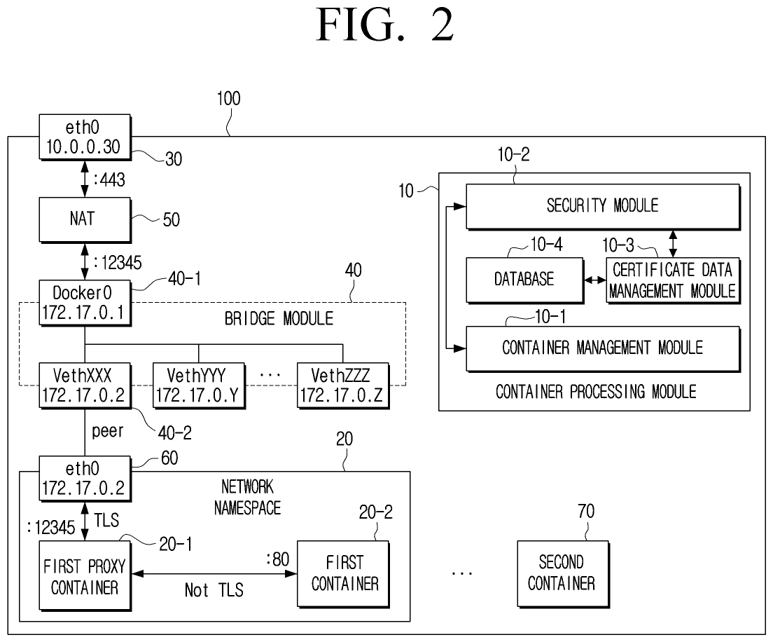

FIG. 2 is a diagram illustrating operations of various modules of the electronic device according to an embodiment of the disclosure.

Referring to FIG. 2, the memory 110 may store data necessary for a container processing module 10 to perform various operations. The container processing module 10 may refer to a module which performs operations of generating, managing, and removing a container or generating, managing, and updating certificate data. The container processing module 10 may include a container management module 10-1, a security module 10-2, a certificate data management module 10-3, and a database 10-4 including certificate data.

Each of the modules 10-1, 10-2, and 10-3 may be included in one container processing module 10 but is not limited thereto. At least one of the modules 10-1, 10-2, and 10-3 may be implemented as a separate module.

The container management module (or container runtime) 10-1 may refer to a module which generates a container or manages the generated container. When a signal for requesting for generation of a container is input, the container management module 10-1 may perform an operation of generating a container based on information included in the input signal.

The security module (or container security daemon) 10-2 may refer to a module which hooks the container generation request signal inputted to the container management module 10-1 and identifies whether the TLS is autonomously applied to the container requested to generate. If it is identified that the TLS is not autonomously applied to the container requested to generate, the security module 10-2 may perform various operations for preferentially distributing a first proxy container for the container requested to generate in a form of a sidecar. The first proxy container and the various operations for distributing the first proxy container will be described below.

The certificate data management module (or certificate manager) 10-3 may refer to a module which performs operations of generating and managing certificate data for performing the communication using the TLS. The certificate data generated by the certificate data management module 10-3 may be stored in the database 10-4.

The container may refer to a virtual space capable of sharing resources of kernels on an operating system (OS) and executing separate applications. The container may include separate applications and a library, a middleware, and the like for executing each application, while sharing the resources of kernels on the operating system.

The operating system virtualization technology using a container may refer to a technology of dividing a kernel space for managing physical resources in the operating system and a user space for executing a user process (i.e., an application program (App)), dividing the user space into a plurality of pieces, and allocating and sharing hardware resources used in each user process.

The virtualization technology using the container may be an OS virtualization method without using a guest OS, which is suitable for application virtualization, since there is almost no consumption of host resources and a period of time required for operating is extremely short. In addition, in the virtualization technology using the container, the virtualization is performed at the OS level, and accordingly, the system infrastructure (e.g., a physical server (Bare Metal), a virtual server (Virtual Machine), and the like of the related art) may be independently configured and distributed. The distribution may refer to opening or delivering an element to outside so that an external device (or external user) is able to use it.

The communicator 120 may be implemented as a separate hardware device including circuitry. The communicator 120 may communicate with external devices (e.g., various types of electronic devices or external servers). The communication connection of the communicator 120 with the external device may include communication via a third device (e.g., a repeater, a hub, an access point, a server, a gateway, or the like).

The communicator 120 may receive a signal input from the external device and transmit various signals to the external device. For example, the communicator 120 may receive a signal for requesting for container generation or a signal input for accessing the distributed container from the external device.

The communicator 120 may include various communication modules to communicate with the external device. In an example, the communicator 120 may include at least one of a wireless communication module and a wired communication module. A network for performing the wireless communication or the wired communication may include at least one of a telecommunication network, for example, a computer network (e.g., LAN or WAN), the Internet, or a telephone network.

The wireless communication module may include a cellular communication module using at least one of LTE, LTE Advance (LTE-A), 5th Generation (5G), code division multiple access (CDMA), wideband CDMA (WCDMA), and the like.

The processor 130 may be electrically connected to the memory 110 to control general operations and functions of the electronic device 100. The processor 130 may be formed of one or a plurality of processors to control the operations of the electronic device 100.

The processor 130 may include one or more of a central processing unit (CPU), a microcontroller unit (MCU), a microprocessing unit (MPU), a controller, an application processor (AP), or a communication processor (CP), and an ARM™ processor for processing digital signals or may be defined as the corresponding term. In addition, in order to perform an artificial intelligence function, the processor 130 may include at least one of a graphics-processing unit (GPU), a neural processing unit (NPU), and a visual processing unit (VPU) which are separate AI dedicated processors.

A process in which the processor 130 performs various operations will be described with reference to FIG. 2. The processor 130 may load data necessary for the modules included in the container processing module 10 to perform various operations from a non-volatile memory to a volatile memory. The loading may refer to an operation of calling data stored in a non-volatile memory and storing it in a volatile memory so that the processor 130 is able to access.

When a first signal for requesting for generating a first container is input from the external device or the like, the processor 130 may input the input first signal to the container management module 10-1. The processor 130 may receive the first signal from the external device via the communicator 120 or from a user via an inputter. The first signal may include information indicating whether certificate data for performing communication using the TLS is included.

In addition, the first signal may include request information for requesting for performing forwarding from a first port of the electronic device (or host) to a second port of the first container. For example, when the first signal is input to port 443 of the host, the first signal may include information for requesting for forwarding the first signal to port 80 of the first container.

Meanwhile, the forwarding may refer to an operation of redirecting a communication request from a combination of a first IP address and a first port number to a combination of a second IP address and a second port number, while a data packet passes through a network gateway such as a router or a host.

When the first signal is input to the container management module 10-1, the processor 130 may hook the first signal via the security module 10-2. The hooking may refer to intercepting an execution process of a process on various computer programs such as an operating system or application software. The processor 130 may identify whether the first container is able to perform the communication using the TLS (i.e., whether the TLS is autonomously applied to the first container), based on the information included in the hooked first signal through the security module 10-2.

The processor 130 may identify whether the first container is able to perform the communication using the TLS based on whether the certificate data for performing the communication using the TLS is present in the information included in the hooked first signal through the security module 10-2. The certificate data for performing the communication using the TLS may include public key certificate data and the like used to prove the ownership of a public key.

According to an embodiment of the disclosure, if the hooked signal does not include the certificate data for performing the communication using the TLS, the processor 130 may identify that the first container is unable to perform the communication using the TLS through the security module 10-2.

According to another embodiment of the disclosure, if the hooked signal includes the certificate data for performing the communication using the TLS, the processor 130 may identify that the first container is able to perform the communication using the TLS through the security module 10-2. Accordingly, the processor 130 may input the first signal to the container management module 10-1 through the security module 10-2. In addition, the processor 130 may generate and distribute the first container based on the first signal through the container management module 10-1.

If it is determined that the first container is unable to perform the communication using the TLS, the processor 130 may obtain first certificate data for performing the communication using the TLS based on the information included in the first signal through the certificate data management module 10-3. The processor 130 may search for certificate data which is generated based on the information included in the first signal and has an unexpired validity period from the database 10-4 through the certificate data management module 10-3.

According to an embodiment of the disclosure, if the certificate data which is generated based on the information included in the first signal and has an unexpired validity period is searched from the database 10-4, the processor 130 may obtain the certificate data searched through the certificate data management module 10-3 as first certificate data. The certificate data generated based on the information included in the first signal may include certificate data for performing TLS communication connection based on image data, a container name, and the like of the first container included in the first signal.

According to another embodiment of the disclosure, if the database 10-4 does not include the certificate data which is generated based on the information included in the first signal and has an unexpired validity period, the processor 130 may generate (or issue) the first certificate data based on the information included in the first signal through the certificate data management module 10-3.

For example, the processor 130 may generate (or issue) the first certificate data based on the image data of the container, the container name, and the like of the information included in the first signal. The image data of the container may refer to data including a library or a source necessary when generating or executing a container. The container name may refer to data for identifying the container.

When the first certificate data is generated (or issued), the processor 130 may store the first certificate data in the database 10-4 through the certificate data management module 10-3. The processor 130 may monitor whether the database 10-4 includes the certificate data having an expired validity period through the certificate data management module 10-3. If it is identified that the database 10-4 includes the certificate data having an expired validity period, the processor 130 may update the certificate data having the expired validity period through the certificate data management module 10-3.

When the first certificate data is obtained, the processor 130 may input a signal for requesting for generation of a first proxy container (or pause-proxy container) 20-1 to the container management module 10-1 through the security module 10-2. The processor 130 may generate the first proxy container 20-1 capable of performing the communication using the TLS based on the first certificate data through the container management module 10-1.

The processor 130 may preferentially distribute the first proxy container 20-1 in a form of a sidecar of a first container 20-2 which will be generated later. The first proxy container 20-1 may be set to share a network namespace with the first container 20-2. Accordingly, the first proxy container 20-1 and the first container 20-2 may share the IP and communicate with a local host. For example, as illustrated in FIG. 2, the first proxy container 20-1 and the first container 20-2 may share the network namespace and share the same IP address (172.17.0.2).

The processor 130 may set so that a signal input from the external device to access the first container 20-2 is input to the first container 20-2 via the first proxy container 20-1. Since the first proxy container 20-1 performs the communication using the TLS, when the signal input from the external device is input to the first container via the first proxy container 20-1, the communication security between the external device and the first container may be reinforced by the TLS.

The processor 130 may change information included in a network address translation (NAT) table 50 so that the signal inputted to access the first container passes through the first proxy container. When information included in the NAT table is changed, the security module 10-2 may end the hooking operation of the first signal. The NAT may refer to a function of converting a private IP address with which the communication is not able to be performed with the outside into an official IP address. The NAT table may refer to that private IP addresses and official IP addresses to be converted from the private IP addresses in a form of a table.

The processor 130 may correct a port forwarding rule included in the NAT table. For example, as illustrated in FIG. 2, it is assumed that the IP address and the port number of the first container are 172.17.0.2:80 and the IP address and the port number of the first proxy container are 172.17.0.2:12345. The processor 130 may change the port forwarding rule included in the NAT table so that all of traffic input to port 443 of the host is forwarded to 172.17.0.2:12345 rather than 172.17.0.2:80.

When the hooking operation of the first signal by the security module 10-2 ends, the processor 130 may distribute the first container 20-2 through the first container management module 10-1. In this case, the processor 130 may distribute the first container 20-2 by setting to share the namespace network with the first proxy container which is distributed previously.

When a second signal for requesting for accessing the distributed first container is input from the external device, the processor 130 may input the second signal to the first proxy container 20-1 by using the information included in the NAT table.

For example, as illustrated in FIG. 2, when the second signal 30 (10.0.0.30:443) for requesting for accessing the first container 20-2 is input from the external device, the processor 130 may identify to input the second signal to 172.17.0.2:12345 (first proxy container) by using the port forwarding rule included in the NAT table.

The processor 130 may obtain information for inputting the second signal to a destination address (e.g., 172.17.0.2:12345) by using a routing table. The routing table may refer to a table including information for converting a destination address into a network route to approach the destination. For example, the routing table may include information as in Table 1 below.

TABLE 1

| Destination | Gateway | Genmask | Interface |
|---|---|---|---|
| 172.17.0.0 | 0.0.0.0 | 255.255.0.0 | docker0 |

The processor 130 may input the second signal to the first proxy container 20-1 through the bridge module 40 based on the information obtained through the routing table. The processor 130 may input the second signal to the first proxy container 20-1 by using a first interface 40-2 corresponding to the network namespace 20 from a bridge module 40 and a second interface 60 having a peer relationship with the first interface 40-2. When the second signal is input to the first proxy container 20-1, the processor 130 may perform the TLS communication connection between the external device and the first proxy container 20-1 by using the first certificate data. After the TLS termination ends, the processor 130 may input the second signal to the first container 20-2 by a proxy function of the first proxy container 20-1. In this case, the first proxy container 20-1 and the first container 20-2 may transmit and receive signals by a communication method not using the TLS (e.g., local host:80 or the like as illustrated in FIG. 2).

After performing the communication connection using the TLS between the first proxy container 20-1 and the external device, when a third signal to be input to the distributed first container is input from the external device, the processor 130 may input the third signal to the first proxy container by using the communication method using the TLS. The processor 130 may input the third signal to the first container by the communication method not using the TLS (e.g., local host:80 or the like as illustrated in FIG. 2) via the first proxy container.

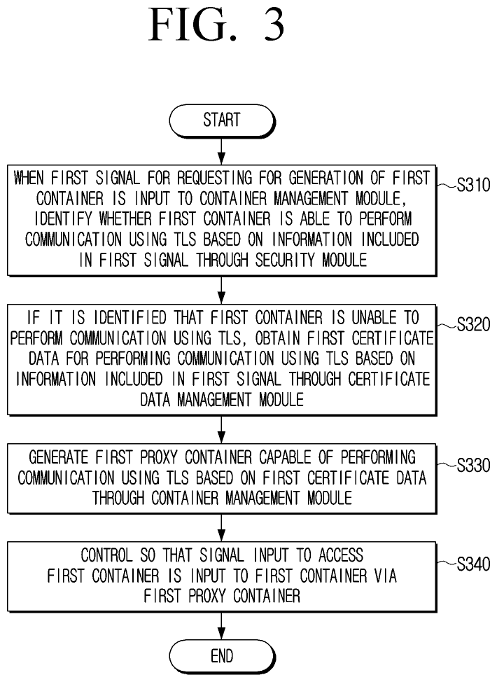

FIG. 3 is a flowchart illustrating a method for controlling the electronic device according to an embodiment of the disclosure.

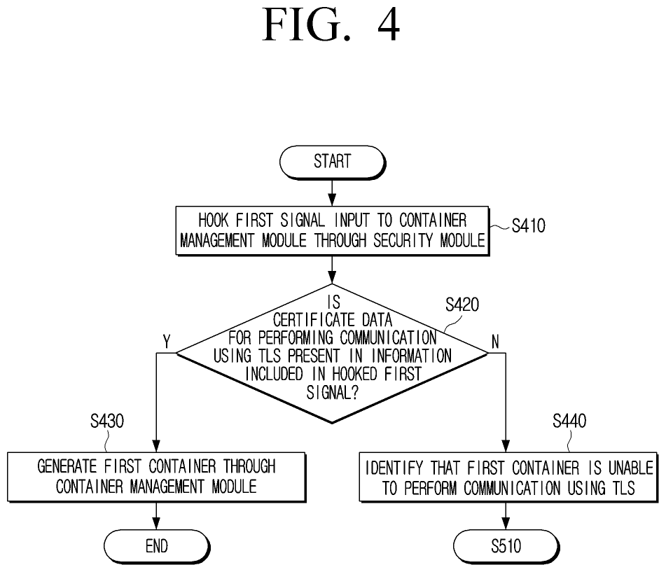

Referring to FIG. 3, when the first signal requesting generation of the first container is inputted to the container management module, the electronic device 100 may identify whether the first container is able to communicate using the TLS based on the information included in the first signal through the security module at operation S310. The electronic device 100 may hook the first signal input to the first container management module through the security module and identify whether the first container is able to communicate using the TLS based on the hooked first signal. The electronic device 100 may identify whether the TLS is autonomously applied to the first container requested to generate. This procedure is described below with reference to FIG. 4.

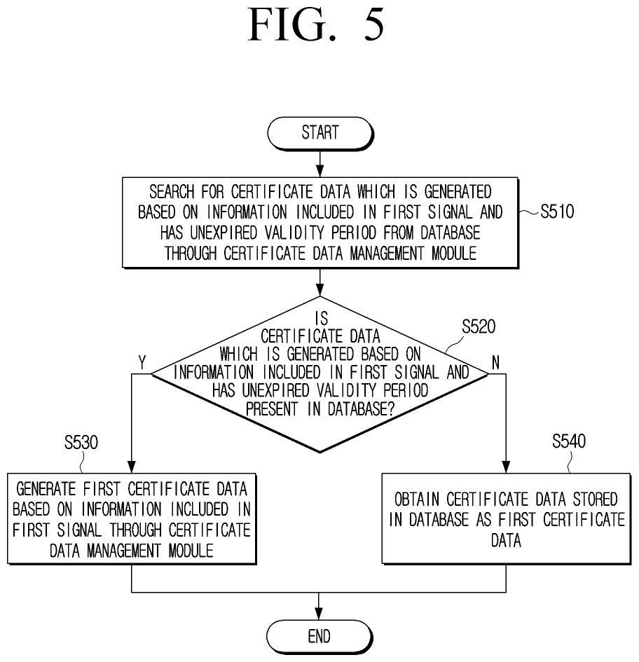

If it is identified that the first container is unable to perform the communication using the TLS, the electronic device 100 may obtain the first certificate data for performing the communication using the TLS based on the information included in the first signal through the certificate data management module at operation S320. The first certificate data is certificate data for performing the TLS communication connection and may include public key certificate data and the like used to prove the ownership of a public key. This procedure is described below with reference to FIG. 5.

The electronic device 100 may generate the first proxy container capable of performing the communication using the TLS based on the first certificate data through the container management module at operation S330. The first proxy container may perform the communication by using the TLS and may share the network namespace with the first container which will be generated later. Accordingly, the first proxy container and the first container may share the same IP and may be communicatively connected to the local host.

The electronic device 100 may control so that the signal inputted to access the first container is input to the first container via the first proxy container at operation S340. The electronic device 100 may change the information (e.g., port forwarding rule and the like) included in the NAT table so that the signal inputted to access the first container is input to the first container via the first proxy container. The electronic device 100 may change the port forwarding rule included in the NAT table so that all of traffic and signals inputted to access the first container from the outside are input to the first proxy container address rather than the first container address.

For example, it is assumed that the port forwarding rule included in the NAT table is originally set so that the traffic input to port 443 of the host is forwarded to the first container address (e.g., 172.17.0.2:80). The electronic device 100 may correct the port forwarding rule included in the NAT table so that the traffic input to port 443 of the host is forwarded to the first proxy container address (172.17.0.2:12345) rather than the first container address.

FIG. 4 is a flowchart illustrating a process in which an electronic device identifies whether a first container is able to perform communication by using TLS according to an embodiment of the disclosure.

Referring to FIG. 4, the electronic device 100 may hook the first signal inputted to the container management module through the security module at operation S410.

The electronic device 100 may identify whether the certificate data for performing the communication using the TLS is present in the information included in the hooked first signal at operation S420. The electronic device 100 may identify whether the TLS is autonomously applied to the first container requested to generate based on whether the hooked first signal includes the certificate data.

If it is identified that the first signal includes the certificate data, the electronic device 100 may generate the first container through the container management module at operation S430. If it is identified that the first signal includes the certificate data, the electronic device 100 may end the operation of the security module and input the first signal to the container management module. The electronic device 100 may generate the first container through the first container management module and distribute the generated first container.

If it is identified that the first signal includes the certificate data, the electronic device 100 may identify that the first container is unable to perform the communication using the TLS at operation S440. The first signal not including the certificate data may imply that the TLS is not autonomously applied to the first container. The operation of the electronic device 100 is described below with reference to FIG. 5.

FIG. 5 is a flowchart illustrating a process in which the electronic device obtains certificate data according to an embodiment of the disclosure. The operation S510 is an operation in a step after the operation S440.

Referring to FIG. 5, the electronic device 100 may search for the certificate data which is generated based on the information included in the first signal and has an unexpired validity period from the database through the certificate data management module at operation S510. The electronic device 100 may identify whether the certificate data which is generated based on the information included in the first signal and has an unexpired validity period is present in the database at operation S520. The database may include certificate data corresponding to each of a plurality of containers.

The first signal may include information on image data and a name capable of identifying the container of the first container. The electronic device 100 may determine whether the certificate data to be generated based on the information included in the first signal is included in the database, and identify whether the validity period of the searched certificate data is not expired.

If the database does not include the certificate data which is generated based on the information included in the first signal and has the unexpired validity period, the electronic device 100 may generate the first certificate data based on the information included in the first signal through the certificate data management module at operation S530. If the certificate data generated based on the information included in the first signal is searched from the database but the validity period is expired, the electronic device 100 may update the searched certificate data and obtain the updated certificate data as the first certificate data.

If the database includes the certificate data which is generated based on the information included in the first signal and has the unexpired validity period, the electronic device 100 may obtain the certificate data stored in the database as the first certificate data at operation S540.

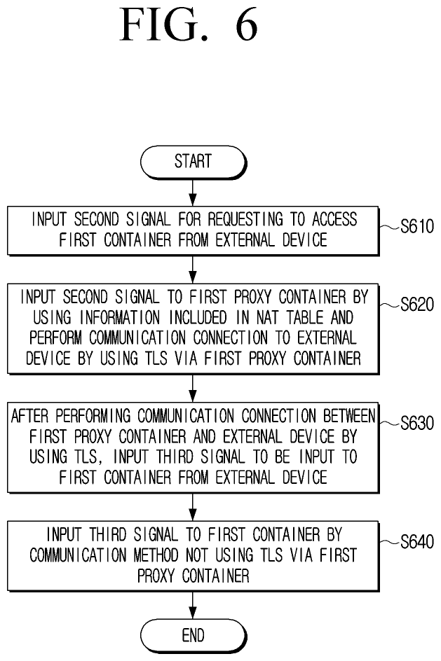

FIG. 6 is a flowchart illustrating a process in which the electronic device performs communication with an external device according to an embodiment of the disclosure. FIG. 6 describes operations after the operation S340 of FIG. 3 as a flowchart illustrating an embodiment after the first container is distributed while sharing the network namespace with the first proxy container distributed previously.

Referring to FIG. 6, the electronic device 100 may receive the second signal for requesting to access the first container from the external device at operation S610. The electronic device 100 may input the second signal to the first proxy container by using the information included in the NAT table and perform the communication connection to the external device by using the TLS via the first proxy container at operation S620.

The NAT table may include the port forwarding rule set so that the signal input to the first container is input to the first proxy container. The electronic device 100 may input the second signal to the first proxy container by using the port forwarding rule. In addition, the electronic device 100 may perform the communication connection to the external device by using the TLS via the first proxy container.

After performing the communication connection between the first proxy container and the external device by using the TLS, the electronic device 100 may receive the third signal to be input to the first container from the external device at operation S630. The electronic device 100 may input the third signal to the first container by the communication method not using the TLS via the first proxy container at operation S640.

The electronic device 100 may reinforce the security of the communication by inputting the signal input from the outside to the first container via the first proxy container. In addition, since the electronic device 100 reinforces the signal input from the outside to be connected to the first container through the TLS, it is not necessary to separately issue and manage public key certificate data or implement logic by applying TLS directly to the first container.

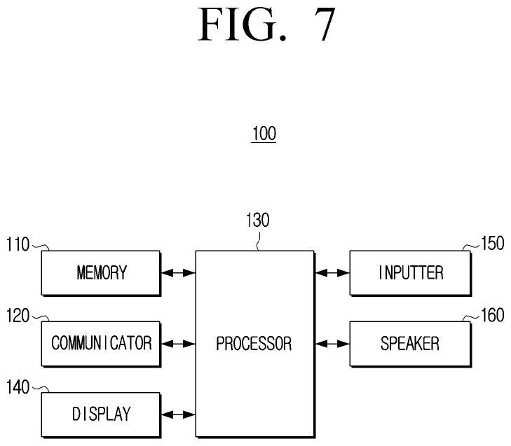

FIG. 7 is a block diagram specifically illustrating the configuration of an electronic device according to an embodiment of the disclosure.

Referring to FIG. 7, the electronic device 100 may include the memory 110, the communicator 120, the processor 130, a display 140, an inputter 150, a speaker 160, and a sensor (not shown). The memory 110, the communicator 120, and the processor 130 have been described in detail with reference to FIG. 1, and therefore the overlapped description will not be repeated.

The display 140 may display information according to the control of the processor 130. The display 140 may display information included in the first signal for requesting for generation of the first container.

The display 140 may display an indicator indicating that the first proxy container and the first container are distributed. In addition, the display 140 may display the NAT table in which the port forwarding rule is changed. In addition, the display 140 may display a message showing that the database includes certificate data having the expired validity period.

The display 140 may be implemented as a touch screen with a touch panel or implemented as a flexible display.

The inputter 150 may include circuitry and receive a user input for controlling the electronic device 100. The inputter 150 may include a touch panel for receiving a user's touch using a user's finger or a stylus pen, a button for receiving user manipulation, and the like. The inputter 150 may also be implemented as other input devices (e.g., keyboard, mouse, motion inputter, and the like).

The speaker 160 outputs not only audio data obtained by executing various processing such as decoding, amplification, or noise filtering by an audio processor, but also various notification sounds or voice messages.

The speaker 160 may output a notification sound notifying that the first proxy container and the first container are distributed. In another example, the speaker 160 may output a notification sound notifying that the database includes certificate data having expired validity period.

It should be noted that the accompanying drawings in the disclosure are not for limiting the technologies disclosed in this disclosure to a specific embodiment, but they should be interpreted to include all modifications, equivalents and/or alternatives of the embodiments of the disclosure. In relation to explanation of the drawings, similar reference numerals may be used for similar elements.

The electronic device 100 according to various embodiments of the disclosure may include at least one of a smartphone, a tablet personal computer (PC), an e-book reader, a desktop personal computer (PC), a laptop personal computer (PC), a netbook computer, a workstation, a server, a personal digital assistant (PDA), a portable multimedia player (PMP), a wearable device, or the like.

The electronic device 100 may include at least one of a television, a digital video disk (DVD) player, an audio player, a refrigerator, an air conditioner, a cleaner, an oven, a microwave, a washing machine, an air purifier, a set-top box, a home automation control panel, a security control panel, a media box (e.g., SAMSUNG HOMESYNC™, APPLE TV™, or GOOGLE TV™), a game console (e.g., XBOX™, PLAYSTATION™), an electronic dictionary, an electronic key, a camcorder, or an electronic frame.

In this disclosure, the terms such as “comprise”, “may comprise”, “consist of”, or “may consist of” are used herein to designate a presence of corresponding features (e.g., constituent elements such as number, function, operation, or part), and not to preclude a presence of additional features.

In this disclosure, expressions such as “A or B”, “at least one of A [and/or] B,”, or “one or more of A [and/or] B,” include all possible combinations of the listed items. For example, “A or B”, “at least one of A and B”, or “at least one of A or B” includes any of (1) at least one A, (2) at least one B, or (3) at least one A and at least one B.

The expressions “first,” “second” and the like used in the disclosure may denote various elements, regardless of order and/or importance, and may be used to distinguish one element from another, and does not limit the elements.

If it is described that a certain element (e.g., first element) is “operatively or communicatively coupled with/to” or is “connected to” another element (e.g., second element), it should be understood that the certain element may be connected to the other element directly or through still another element (e.g., third element). On the other hand, if it is described that a certain element (e.g., first element) is “directly coupled to” or “directly connected to” another element (e.g., second element), it may be understood that there is no element (e.g., third element) between the certain element and the other element.

Also, the expression “configured to” used in the disclosure may be interchangeably used with other expressions such as “suitable for,” “having the capacity to,” “designed to,” “adapted to,” “made to,” and “capable of,” depending on cases. The expression “configured to” does not necessarily refer to a device being “specifically designed to” in terms of hardware. Instead, under some circumstances, the expression “a device configured to” may refer to the device being “capable of” performing an operation together with another device or component. For example, the phrase “a unit or a processor configured (or set) to perform A, B, and C” may refer, for example, and without limitation, to a dedicated processor (e.g., an embedded processor) for performing the corresponding operations, a generic-purpose processor (e.g., a central processing unit (CPU) or an application processor), or the like, that can perform the corresponding operations by executing one or more software programs stored in a memory device.

Various embodiments of the disclosure may be implemented as software including instructions stored in machine (e.g., computer)-readable storage media. The machine is a device which invokes instructions stored in the storage medium and is operated according to the invoked instructions, and may include a server cloud according to the disclosure. In a case where the instruction is executed by a processor, the processor may perform a function corresponding to the instruction directly or using other elements under the control of the processor.

The instruction may include a code made by a compiler or a code executable by an interpreter. The machine-readable storage medium may be provided in a form of a non-transitory storage medium. Here, the “non-transitory storage medium” is tangible and may not include signals, and it does not distinguish that data is semi-permanently or temporarily stored in the storage medium. For example, the “non-transitory storage medium” may include a buffer temporarily storing data.

According to an embodiment of the disclosure, the methods according to various embodiments disclosed in this disclosure may be provided in a computer program product. The computer program product may be exchanged between a seller and a purchaser as a commercially available product. The computer program product may be distributed in the form of a machine-readable storage medium (e.g., compact disc read only memory (CD-ROM)) or distributed online through an application store (e.g., PlayStore™). In a case of the on-line distribution, at least a part of the computer program product (e.g., downloadable app) may be at least temporarily stored or temporarily generated in a storage medium such as a memory of a server of a manufacturer, a server of an application store, or a relay server.

Each of the elements (e.g., a module or a program) according to various embodiments described above may include a single entity or a plurality of entities, and some sub-elements of the abovementioned sub-elements may be omitted or other sub-elements may be further included in various embodiments. Alternatively or additionally, some elements (e.g., modules or programs) may be integrated into one entity to perform the same or similar functions performed by each corresponding element prior to the integration. Operations performed by a module, a program, or other elements, in accordance with various embodiments, may be performed sequentially, in a parallel, repetitive, or heuristically manner, or at least some operations may be performed in a different order, omitted, or may add a different operation.

While the disclosure has been shown and described with reference to various embodiments thereof, it will be understood by those skilled in the art that various changes in form and details may be made therein without departing from the spirit and scope of the disclosure as defined by the appended claims and their equivalents.

What is claimed is:

1. An electronic device comprising:
a memory; and
a processor configured to:
based on a first signal requesting generation of a first container being input to a container management module, identify whether the first container is able to communicate using Transport Layer Security (TLS) based on information included in the first signal through a security module,
based on the identification that the first container is unable to perform the communication using the TLS, obtain first certificate data for communicating using the TLS based on the information included in the first signal through a certificate data management module,
generate a first proxy container that is able to communicate using the TLS based on the first certificate data through the container management module, and
control so that a signal inputted to access the first container is input to the first container via the first proxy container.

2. The device according to claim 1, wherein the processor is further configured to:
hook the first signal inputted to the container management module through the security module; and
identify whether the first container is able to communicate using the TLS based on whether certificate data for communicating using the TLS is present in the information included in the hooked first signal.

3. The device according to claim 2, wherein the processor is further configured to:
based on the certificate data for communicating using the TLS being absent in the hooked signal, identify that the first container is unable to communicate using the TLS; and
based on the certificate data for performing the communication using the TLS being present in the hooked signal, identify that the first container is able to communicate using the TLS and generate the first container through the container management module.

4. The device according to claim 1,
wherein the memory stores a database including a plurality of pieces of certificate data, and
wherein the processor is further configured to:
based on the identification that the first container is unable to communicate using the TLS, search for certificate data that is generated based on the information included in the first signal and has an unexpired validity period from the database through the certificate data management module, and
based on the certificate data that is generated based on the information included in the first signal and has the unexpired validity period being included the database, obtain the certificate data included in the database as the first certificate data.

5. The device according to claim 4, wherein the processor is further configured to, based on the certificate data that is generated based on the information included in the first signal and has the unexpired validity period not being included in the database, generate the first certificate data based on the information included in the first signal through the certificate data management module.

6. The device according to claim 1, wherein the processor is further configured to:
distribute the first proxy container in a form of a sidecar of the first container; and
set the first container to share a network namespace with the distributed first proxy container,
wherein the same Internet protocol (IP) address is allocated to the first container and the first proxy container.

7. The device according to claim 1, wherein the processor is further configured to change information included in a network address translation (NAT) table so that a signal inputted to access the first container is input to the first container via the first proxy container.

8. The device according to claim 7, wherein the processor is further configured to:
based on a second signal requesting to access the first container being input form an external device, input the second signal to the first proxy container by using the information included in the NAT table; and
connect to the external device using the TLS via the first proxy container.

9. The device according to claim 8, wherein the processor is further configured to:
based on a third signal to be input to the first container being input from the external device after connecting the first proxy container to the external device using the TLS, input the third signal to the first proxy container by a communication method using the TLS; and
input the third signal to the first container by a communication method not using the TLS via the first proxy container.

10. The device according to claim 4, wherein the processor is configured to:
monitor whether a certificate data having an expired validity period is present in the database through the certificate data management module; and
update the validity period based on the expired certificate data being present.

11. A method for controlling an electronic device, the method comprising:
based on a first signal requesting generation of a first container being input to a container management module, identifying whether the first container is able to communicate using Transport Layer Security (TLS) based on information included in the first signal through a security module;
based on the identification that the first container is unable to communicate using the TLS, obtaining first certificate data for communicating using the TLS based on the information included in the first signal through a certificate data management module;
generating a first proxy container that is able to communicate using the TLS based on the first certificate data through the container management module; and
controlling so that a signal inputted to access the first container is input to the first container via the first proxy container.

12. The method according to claim 11, wherein the identifying of whether the first container is able to communicate using TLS comprises:
hooking the first signal inputted to the container management module through the security module; and
identifying whether the first container is able to communicate using the TLS based on whether certificate data for communicating using the TLS is present in the information included in the hooked first signal.

13. The method according to claim 12, wherein the identifying of whether the first container is able to communicate using the TLS comprises:
based on the certificate data for communicating using the TLS being absent in the hooked signal, identifying that the first container is unable to communicate using the TLS; and
based on the certificate data for communicating using the TLS being present in the hooked signal, identifying that the first container is able to communicate using the TLS and generating the first container through the container management module.

14. The method according to claim 11, wherein the obtaining comprises:
based on the identification that the first container is unable to communicate using the TLS, searching for certificate data that is generated based on the information included in the first signal and has an unexpired validity period from a database included in a memory of the electronic device through the certificate data management module; and
based on the certificate data that is generated based on the information included in the first signal and has the unexpired validity period being included in the database, obtaining the certificate data included in the database as the first certificate data.

15. The method according to claim 14, wherein the searching for the certificate data comprises, based on the certificate data that is generated based on the information included in the first signal and has the unexpired validity period not being included in the database, generating the first certificate data based on the information included in the first signal through the certificate data management module.
